(19) United States
(12) Patent Application Publication
(10) Pub. No.: US 2007/0249364 A1
(43) Pub. Date: Oct. 25, 2007

(54) PRECISION LEVEL MANAGEMENT FOR LOCATION REPORTING

(75) Inventors: Matthew Bells, Waterloo (CA); Gerhard Dietrich Klassen, Waterloo (CA); Samer Fahmy, Waterloo (CA); Garth Adam Newton, Waterloo (CA)

Correspondence Address: INTEGRAL INTELLECTUAL PROPERTY INC., 1370 DON MILLS ROAD, SUITE 300, TORONTO, ON, M3B 3N7, CA

(73) Assignee: Research In Motion Limited, Waterloo (CA)

(21) Appl. No.: 11/380,016

(22) Filed: Apr. 25, 2006

(51) Int. Cl. H04Q 7/20

(52) U.S. Cl. 455/456.1; 709/223

(57) ABSTRACT

A mobile device provides its location information to contacts of a user of the mobile device. A contact has a particular precision level assigned thereto from a set of two or more precision levels. The assignment of precision levels to contacts is according to one or more criteria. The mobile device ensures that any location information of the mobile device provided to the contact is not more precise than the precision level currently assigned to the contact.

### BACKGROUND

There are many techniques by which a mobile device may become aware of its approximate location. In one example, a mobile device that includes a GPS (Global Positioning System) receiver can detect signals from GPS satellites to estimate its location. The precision of a location derived from a GPS system is generally in the range of a few meters to tens of meters, although some receivers can achieve higher accuracy.

In another example, a mobile device that includes a cellular communication interface and is able to communicate with a PLMN (public/private land mobile network) base station may be able to retrieve the location of the base station. Since base stations can have a coverage area of several kilometers, approximating the location of the mobile device by using the location of the base station has a precision generally in the range of 100 meters to 35 kilometers.

In a technique known as AGPS (Assisted Global Positioning System), an assistance server communicates with the mobile device via a network and provides any or a combination of the following types of data to the GPS receiver of the mobile device: precise GPS satellite orbit and clock information; initial position and time estimate; satellite selection, range and range-rate information. The assistance server is also able to compute position solutions, leaving the GPS receiver with the sole job of collecting range measurements. AGPS can reduce the amount of time required to determine the location of the mobile device.

In a yet another example, the location of a mobile device that includes a wireless local area network (WLAN) interface may be approximated from the fixed and known location of an access point (AP) it communicates with. Depending on the WLAN protocol used and the structure of the WLAN, the mobile device's location may be approximated with a precision of a few meters to hundreds of meters.

For various reasons, a user of the mobile device may want to provide information about the mobile device's location to other people or to services.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is a flowchart of an exemplary method in a mobile device for assigning precision levels to contacts;

FIG. 2 is a flowchart of an exemplary method in a mobile device for providing its location information to a contact;

FIG. 3 is a flowchart of an exemplary method in a mobile device equipped with a GPS receiver for determining its location; and

FIG. 4 is a flowchart of an exemplary method in a communication device for handling a message that is received with location information about the sender of the message; and

FIG. 5 is a simplified illustration of an exemplary communication system involving a mobile device.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

A mobile device that includes a communication interface may be used to send messages to contacts of its user. Depending on the applications installed on the mobile device, the messages may be Short Message Service (SMS) messages, e-mail messages, instant messages and the like. In some applications, presence information about the user (e.g., busy, available, etc.) is shared with contacts. Examples for the architecture of the communication system in which the messages and/or presence information are sent include peer-to-peer and client-server.

An enhanced messaging experience is possible if location information for the mobile device is shared with a contact. The location information may be sent to the contact along with a message from the user and/or with the presence information and/or with any notifications or other communications between the mobile device and the contact's communication device.

Some mobile stations, especially those equipped with GPS receivers, are able to determine their location with a high degree of precision. But the user may not wish to share his location with the same precision to all contacts. For example, if the user sends a work-related message to his boss while sitting in a movie theater, the user is unlikely to want the message to be accompanied by precise location information that indicates that the user is not at his workplace.

Accordingly, in some embodiments of the invention, the location of a mobile device is provided to a contact of a user of the mobile device at a precision that does not exceed a precision level assigned to the contact. The precision level is selectable from a set of two or more dissimilar precision levels, and is selected based on one or more criteria.

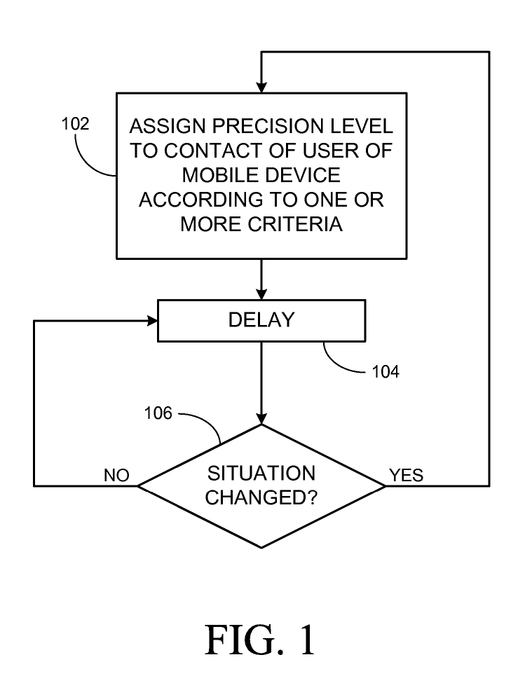

FIG. 1 is a flowchart of an exemplary method in a mobile device for assigning precision levels to contacts. At 102, the mobile device assigns a particular precision level from a set of two or more dissimilar precision levels to a contact. This assignment is made according to one or more criteria. After a suitable delay at 104, it is checked at 106 whether the situation has changed. If not, then after another suitable delay at 104, it is checked again at 106 whether the situation has changed. If the situation has changed, then a different precision level may be assigned to the contact at 102, according to the one or more criteria that are now evaluated based upon the changed situation.

The method of FIG. 1 may be modified to be event-driven instead of or in addition to incorporating the delay at 104.

A precision level may be defined in terms of distance. For example, a precision level may be defined as “within 100 meters”, “within 3 miles” or “within 10 miles”.

The set of precision levels may include, for example, continent, country, state, province, county, city, neighborhood, street, postal code, intersection, building, campus, address and coordinates (e.g., latitude and longitude).

One or more criteria may be applied to determine which precision level to assign to which contact. The criteria may include whether the contact belongs to a particular group of contacts. For example, a user may decide to assign a precision level of “continent” or “country” to business contacts that she met at a conference, a precision level of “city” to her customers, a precision level of “neighborhood” to her friends and a precision level of “coordinates” to her sister.

The criteria may be contextual. For example, when the mobile device detects that its user is at work (perhaps because the mobile device is connected to a work network as opposed to a public network), friends of the user are assigned a precision level that does not enable them to track the user while at work, while co-workers are assigned a more precise precision level. When the mobile device detects that its user is not at work (perhaps because the mobile device is no longer connected to the work network), co-workers are denied any location information about the mobile device, while friends are assigned their respective, default not-at-work precision levels.

The criteria may include date and/or time. For example, a contact that is normally denied any location information may be temporarily assigned a precision level and provided with location information during the 30 minutes prior to a calendar meeting in which the contact is participating and that is recorded in the mobile device. In another example, a precision level may be in the form of “within a defined area sometime in the past X minutes”. In yet another example, the precision level of a contact may be incrementally increased (to become more precise) more than once prior to a date or time.

The criteria may include the distance between the mobile device and a particular location. For example, the farther you are from home, work, the gym, your favorite pub, or your favorite golf course, the less precise you may want the location information about your mobile device to be.

If the location of the contact is known (or can be assumed), the criteria may include the absolute location of the contact, the distance between the contact and the mobile device, and/or the distance between the contact and a particular location. For example, if the user of the mobile device and a particular contact are scheduled to have a meeting, precision levels of increasing accuracy may be assigned to the contact as the contact and the user approach one another, or as the contact nears the appointed meeting place. Precision levels may be updated automatically in proportion to proximity. For example, while the contact is 100 km away, the position may be updated every 15 minutes, and while the contact is less than 100 m away, the position may be updated every 10 seconds. The location information may be sent encrypted with a one-time session key until both parties are deemed to have met. The parties may be deemed to have met if the mobile device of the user and the communication device of the contact are in the same place, or the time for the meeting has elapsed, or the meeting was cancelled in the mobile device.

Once a contact has been assigned a precision level, the mobile device ensures that any location information of the mobile device provided to that contact is not more precise than the precision level currently assigned to the contact.

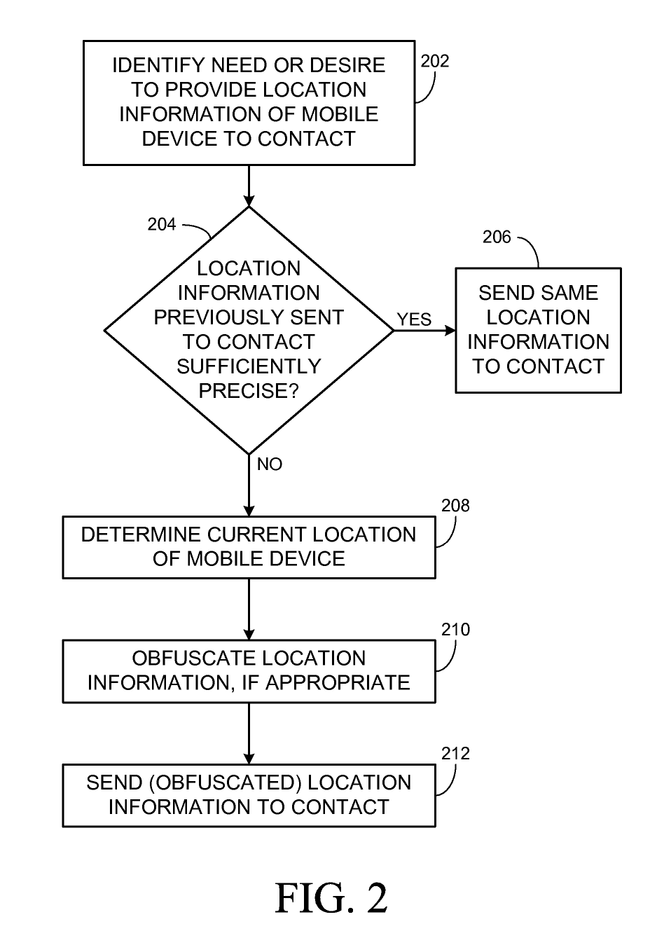

FIG. 2 is a flowchart of an exemplary method in a mobile device for providing its location information to a contact. At 202, a need or desire to provide location information of the mobile device to the contact is identified. For example, perhaps presence information about the user of the mobile device is about to be sent to the contact, or perhaps the mobile device is about to send a message from the user to the contact.

It is possible to deduce a more accurate location from the distribution of less accurate location reports. To prevent this, at 204, the mobile device determines whether the location information that was most recently sent to the contact is sufficiently precise according to the precision level of the contact. For example, if the precision level of the contact is “neighborhood” and the mobile device is still within the same neighborhood as previously indicated to the contact, then the location information that was most recently sent is indeed sufficiently precise. In that case, at 206, the same location information that was most recently sent to the contact is sent again. Alternatively, no location information is sent to the contact. In order to enable this, the mobile device keeps a record of each location that it has sent. For example, the mobile device may store one location per contact, perhaps as a field in the contact or as a map or hashtable that associates the contact with the last location sent to it. In another example, the mobile device may store one location per precision level, and the contacts are associated with precision levels. In that case, when the location changes for a given precision level, then contacts associated with that precision are updated.

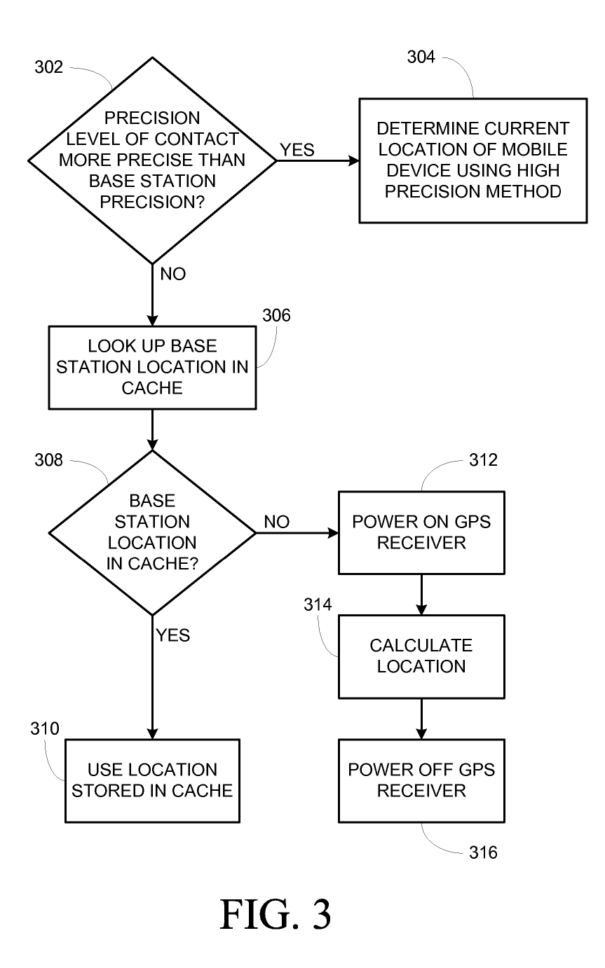

If the location information most recently sent to the contact is not sufficiently accurate according to the precision level of the contact, then at 208, the current location of the mobile device is determined. For example, if the mobile device is equipped with a GPS receiver, the coordinates of the mobile device may be ascertained. In another example, if the mobile device can communicate with a base station of a PLMN network, the mobile device may receive the location of the base station. In yet another example, the mobile device may approximate its location based on the location of a WLAN access point with which it can communicate. Any suitable method for determining the location of the mobile device may be used. FIG. 3 is a flowchart of an exemplary method for determining the location of the mobile device.

If the location information determined at 208 is more precise than the precision level assigned to the contact, then at 210 the mobile device obfuscates the location information, for example, by applying noise to or rounding the location information. For example, if the location information determined at 208 is an address, and the precision level assigned to the contact is “postal code”, then the location information may be filtered to the postal code of the address. In another example, the mobile device may update the location more often than necessary (this is a form of time noise). In a further example, the mobile device may allow the location information to be inaccurate for an amount of time prior to an update. For example, if updates are every 15 minutes, and the mobile device is slightly out of the region 2 minutes after the most recent update, the mobile device may wait until it has been out of the region for 15 minutes before sending its updated location.

At 212, the mobile device sends the location information (as obfuscated at 210, if applicable) to the contact.

FIG. 3 is a flowchart of an exemplary method in a mobile device equipped with a GPS receiver for determining its location.

At 302, it is checked whether the precision level of the contact is more precise than the precision of base station locations. If so, then a high precision method for determining the current location of the mobile device is used at 304. For example, the location of the base station has a precision generally in the range of 100 meters to 35 kilometers. If the precision level of the contact to whom location information about the mobile device is to be sent is “within 25 meters”, then a high precision method such as GPS is used to determine the current location of the mobile device.

Otherwise, at 306 the mobile device looks up in its cache the location of the base station with which it is communicating. If the location of the base station is found in the cache (as checked at 308), then at 310, the location found in the cache is used as an approximation of the location of the mobile device.

If the location of the base station is not found in the cache, this may be due to the mobile device having recently changed with which base station it is connected. At 312 the GPS receiver of the mobile device is powered on, at 314 the GPS receiver is used to calculate the mobile device's location, which is stored in the cache, and at 316 the GPS receiver is powered off. Alternatively, if the mobile device is able to estimate its location by another method, that estimated location may be stored in the cache instead. For example, the mobile device may request the location of a base station with which it is communicating, either directly from the base station or from a server as described in U.S. patent application Ser. No. 11/390,214 filed Mar. 28, 2006, which is incorporated by reference herein.

It will be appreciated that power savings in the mobile device may be achieved by not monitoring GPS data unless high precision is required or the mobile device switches base stations.

Alternatively, if the location of the base station is not found in the cache, the mobile device may communicate with the base station it is currently connected to in order to obtain the location of the base station and store it in the cache.

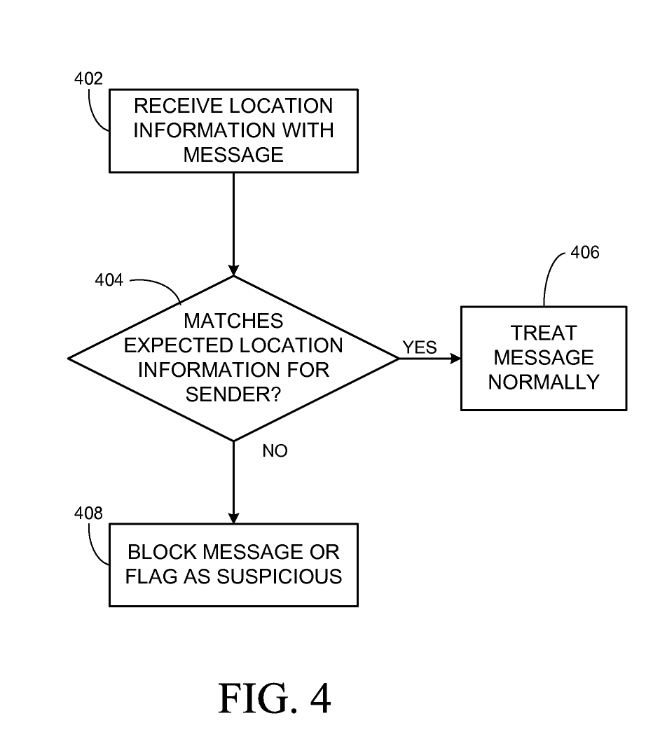

FIG. 4 is a flowchart of an exemplary method in a communication device for handling a message that is received with location information about the sender of the message. At 402, the location information about the sender is received by the communication device along with the message.

At 404, the communication device checks whether the location information received with the message matches the expected location information for the sender of the message. For example, the expected location may be culled from an address book stored on or accessible by the communication device. In another example, the expected location may be defined by the user of the communication device. In yet another example, the communication device may store previous known locations of the contact, all of which are deemed expected locations.

If the location information matches, then at 406 the communication device treats the message as usual. But if there is a mismatch, then at 408 the communication device blocks the message or flags it as suspicious.

The location information about the sender that accompanies a message may therefore be used to provide a certain level of authentication. An unknown third party would have a hard time spoofing where the message should be coming from. This authentication may help eliminate spam and virus-based e-mail, since a person or automatic program that generates such messages would not necessarily have access to the expected location information.

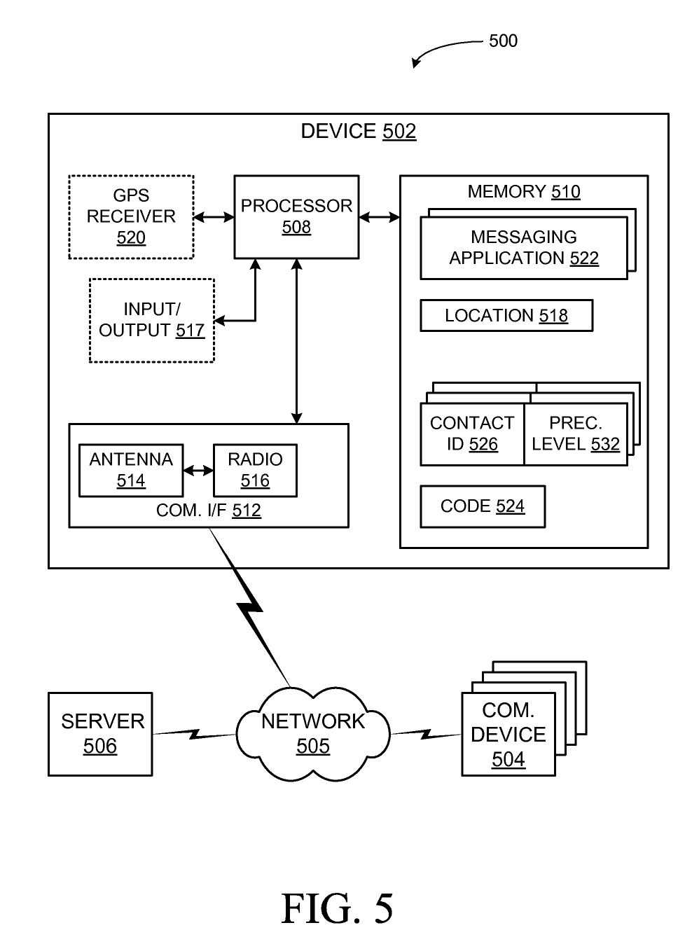

FIG. 5 is an illustration of an exemplary communication system involving a mobile device. A system 500 includes a mobile device 502, communication devices 504 and a network 505.

Mobile device 502 includes a processor 508, a memory 510 coupled to processor 508, and a wireless communication interface 512 coupled to processor 508. Wireless communication interface 512 includes at least an antenna 514 and a radio 516 coupled to antenna 514. Mobile device 502 may also include one or more input and/or output components 517.

Using any current or future technique, device 502 is able to obtain an approximation of its physical location and to store information 518 about this approximation in memory 510. For example, mobile device 502 may include a GPS receiver 520 coupled to processor 508. In another example, mobile device 502 may request the location of a base station with which it is communicating, either directly from the base station or from a server as described in U.S. patent application Ser. No. 11/390,214 filed Mar. 28, 2006 and use the base station location as an approximation of its own location.

Mobile device 502 is able to communicate with network 505 via wireless communication interface 512. Mobile device 502 may provide information about its location to one or more of communication devices 504, and/or to server 506. One or more of communication devices 504 may poll server 506 for the location information of mobile device 502.

Memory 510 may store one or more messaging applications 522. Messaging applications 522, when executed by processor 508, may enable the user of mobile device to send messages to contacts of the user, which are sent through wireless communication interface 512.

Memory 510 may store code 524, which when executed by processor 508, assigns to a contact, identified in memory 510 by an identifier 526, a precision level 532 from a set of two or more dissimilar precision levels. Code 524 also ensures that any location information of the mobile device provided to the contact is not more precise than the precision level currently assigned to the contact. Code 524 may implement the methods of FIGS. 1, 2 and 3. Precision levels 532 may be selected by a user of mobile device 502, by software and/or by a service.

A non-exhaustive list of examples for network 505 includes any or combination of:

a) wired networks such as the Internet, intranets, Ethernet networks, token rings, Universal Serial Bus (USB), wired networks according to the IEEE 1394-1995, IEEE 1394a-2000, and IEEE 1394b standards (commonly known as “FireWire”), or any combination thereof,

b) cellular networks such as Direct Sequence - Code Division Multiple Access (DS-CDMA) cellular radiotelephone communication, Global System for Mobile Communications (GSM) cellular radiotelephone, North American Digital Cellular (NADC) cellular radiotelephone, Time Division Multiple Access (TDMA), Extended-TDMA (E-TDMA) cellular radiotelephone, wideband CDMA (WCDMA), General Packet Radio Service (GPRS), Enhanced Data for GSM Evolution (EDGE), 3G and 4G communication, and the like; and

c) wireless local area networks such as IEEE 802.11, Bluetooth®, Zigbee™, ultra wideband (UWB) and the like; and

d) optical communication networks.

Network 505 may include any combination of additional communication devices (not shown) such as gateways, routers, switches, and the like.

A non-exhaustive list of examples for device 502 includes a mobile terminal, a GPS device, a laptop computer, a personal digital assistant (PDA), a hand-held computer, a cellular telephone, a smart cellphone, an electronic mail (Email) client, and the like.

A non-exhaustive list of examples for devices 504 includes workstations, notebook computers, laptop computers, servers, desktop personal computers, personal digital assistants (PDAs), hand-held computers, cellular telephones, smart cellphones, electronic mail (Email) clients, programmable consumer electronics, network PCs, and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method in a mobile device for providing its location information to contacts of a user of the mobile device, the method comprising:
assigning to a contact, according to one or more criteria, a precision level from a set of two or more precision levels; and
ensuring that any location information of the mobile device provided to the contact is not more precise than the precision level currently assigned to the contact.

2. The method of claim 1, further comprising:
providing updated location information for the mobile device to the contact if location information previously provided to the contact is inaccurate for the precision level assigned to the contact.

3. The method of claim 1, further comprising:
assigning to the contact a different precision level from the set; and
providing updated location information for the mobile device to the contact if location information previously provided to the contact is inaccurate for the different precision level.

4. The method of claim 1, wherein ensuring that any location information of the mobile device provided to the contact is not more precise than the precision level currently assigned to the contact includes:
obfuscating the location information provided to the contact.

5. The method of claim 1, wherein the set includes any of the following precision levels: continent, country, state, province, county, city, neighborhood, street, postal code, intersection, building, campus, address and coordinates.

6. The method of claim 1, wherein the set includes at least one precision level defined in terms of distance.

7. The method of claim 1, wherein the criteria includes whether the contact belongs to a particular group of contacts.

8. The method of claim 1, wherein the criteria is contextual.

9. The method of claim 1, wherein the criteria includes a date or time.

10. The method of claim 1, wherein the criteria includes the distance between the mobile device and a particular location.

11. The method of claim 1, wherein the criteria includes an absolute location of the contact.

12. The method of claim 1, wherein the criteria includes the distance between the contact and the mobile device.

13. The method of claim 1, wherein the criteria includes the distance between the contact and a particular location.

14. The method of claim 1, wherein the criteria includes that the contact is within a defined area sometime during a defined period of time.

15. The method of claim 14, wherein the defined period of time is relative to the time that the precision level is being assigned to the contact.

16. The method of claim 1, further comprising:
storing in a cache of the mobile device a location of a base station to which the mobile device is connected; and
if the stored location of the base station is sufficiently precise for the contact according to the precision level currently assigned thereto, providing the contact with the stored location of the base station.

17. A method in a communication device, the method comprising:
receiving, with a message, location information about a sender of the message; and
blocking the message or flagging the message as suspicious if the location information does not match any expected locations of the sender.

18. A mobile device comprising:
means for determining its location;
a memory to store information of contacts of a user of the mobile device;
a communication interface through which the mobile device is able to send messages to the contacts;
a processor coupled to the memory and the communication interface,
wherein the memory is to store code, which when executed by the processor, assigns to a contact, according to one or more criteria, a precision level from a set of two or more precision levels and ensures that any location information of the mobile device provided to the contact is not more precise than the precision level currently assigned to the contact.

19. The mobile device of claim 18, wherein said means for determining its location comprises:
a Global Positioning System receiver.
